(19) United States
(12) Patent Application Publication
(10) Pub. No.: US 2020/0094434 A1
(43) Pub. Date: Mar. 26, 2020

(54) Strip-making Machine for Bamboo Core Barrel with Precise Center-aligned Cutting

(71) Applicant: Fu Ho WONG, Hong Kong (HK)

(72) Inventor: Fu Ho WONG, Hong Kong (HK)

(21) Appl. No.: 16/209,922

(22) Filed: Dec. 4, 2018

(30) Foreign Application Priority Data
Sep. 20, 2018 (CN) 201811101151.0

(51) Int. Cl. B27L 7/06; B27J 1/00

(52) U.S. Cl. CPC B27L 7/06; B27J 1/00

(57) ABSTRACT

The invention relates to a strip-making machine for bamboo core barrel with precise center-aligned cutting which includes a control cabinet. A rotating tray is arranged on a side of the control cabinet. A conveyor belt and a bamboo breaking device are mounted on the control cabinet. The conveyor belt is connected between the rotating tray and the bamboo breaking device. The bamboo breaking device is provided with a vertically placed material tube. A cone-shaped blade adapter is installed below the inside of the material tube. A plurality of circumferentially distributed blades are mounted on the outer wall of the blade adapter. The bamboo breaking device further includes a double-stroke hydraulic cylinder disposed above the material tube. The top of the piston rod of the double-stroke hydraulic cylinder is equipped with a pressure block. The pressure block can be driven into the inside of the material tube by the double-stroke hydraulic cylinder. In the present invention, the bamboo core barrel is cut into a plurality of strip-shaped materials with equal arc length by a plurality of blades distributed along the circumference of the blade adapter. It can greatly reduce the amount of waste generated during subsequent processing and reduce the production cost.

### FIELD OF THE INVENTION

The invention relates to the field of processing bamboo products. In particular, the invention relates to a strip-making machine for bamboo core barrel with precise center-aligned cutting.

### BACKGROUND

Bamboo products are used by more and more families because of their rich shapes, beautiful texture and natural environmental protection. Bamboo processing is a resource-proliferating industry. It will not destroy the environment due to industrial development, which achieves sustainable use, and meets economic and ecological needs. Bamboo must be processed into strips to make bamboo products. Most of the prior art uses manual methods in cooperation with tools. After many processes and long time, the bamboo can be processed into strips. There are automated bamboo strip-making machines. Most of them use a top press machine to transport bamboo to the bamboo breaker. The bamboo breaker mostly use a plurality of cutting knives that are rounded into a circular shape. The bamboo forcibly passes through the bamboo breaker so that the bamboo is cut into strips. The problem with this is that the bamboo is a natural product, and it is not a regular tubular body. The diameters of the bamboos are different, and the parts of the inter-sections of bamboos are not the same, so there is no guarantee during the cutting process that the center of the bamboo is kept in the same line with the center of the plurality of cutting knives. When the center of the bamboo is not in line with the center of the plurality of cutting knives, the bamboo portion at the higher part has longer arc of cross section during the cutting. It causes different arc lengths of the individual bamboo strips to be made. Thus, in the subsequent manufacturing process, the bamboo strips are made into regular bodies, such as block bodies, which need to be cut. Much waste is generated due to the difference in the arc length of the bamboo strips, which greatly increases the production cost of the manufacturers.

### SUMMARY OF THE INVENTION

The object of the present invention is to overcome the deficiency of prior art by providing a strip-making machine for bamboo core barrel with precise center-aligned cutting.

To solve the above deficiency, the present invention provides the following technical solution.

A strip-making machine for bamboo core barrel with precise center-aligned cutting includes a control cabinet. A rotating tray is arranged on a side of the control cabinet. A conveyor belt and a bamboo breaking device are mounted on the control cabinet. The conveyor belt is connected between the rotating tray and the bamboo breaking device. The bamboo breaking device is provided with a vertically placed material tube. A cone-shaped blade adapter is installed below the inside of the material tube. A plurality of circumferentially distributed blades are mounted on the outer wall of the blade adapter. The bamboo breaking device further includes a double-stroke hydraulic cylinder disposed above the material tube. The top of the piston rod of the double-stroke hydraulic cylinder is equipped with a pressure block. The pressure block can be driven into the inside of the material tube by the double-stroke hydraulic cylinder.

Further, baffles are arranged on both sides and the end of the conveyor belt. The height of the baffle corresponds to the height of the bamboo core barrel. A push cylinder is mounted on one side of material position of the end of the conveyor belt. The pushing direction of the push cylinder is perpendicular to the conveying direction of the conveyor belt. The push cylinder is used to push the bamboo core barrel on the material position of the end of the conveyor belt to the bamboo breaking device. The corresponding bamboo breaking device is disposed on the side of the conveyor belt and disposed opposite to the push cylinder.

Further, the push cylinder is a three-bar cylinder. An end of three output rod of the push cylinder is equipped with a material support. The height of the material support corresponds to the height of bamboo core barrel. The front side of the material support is provided with a curved surface.

Further, the bamboo breaking device further includes a first flat plate. The upper end surface of the first flat plate is in the same plane as the bearing surface of the conveyor belt. The first flat plate is provided with a circular hole. The position of the circular hole corresponds to the position of the stroke end of the push cylinder. The material tube is installed below the first flat plate and the material tube is disposed coaxially with the circular hole. The push cylinder can deliver the bamboo core barrel on the material position of the end of the conveyor belt to a position above the circular hole of the first flat plate. The bamboo core barrel passes through the circular hole by the gravity and fall inside the material tube.

Further, the first flat plate is provided with a mounting bracket. The top of the mounting bracket is suspended above the circular hole. The double-stroke hydraulic cylinder is fixed above the top of the mounting bracket. The pressure block is disposed under the top of the mounting bracket. The piston rod of the double-stroke hydraulic cylinder passes through the top of the mounting bracket and connects to the pressure block. The first stroke distance of the double-stroke hydraulic cylinder corresponds to the distance between the top of the mounting bracket and the first flat plate. The second stroke distance corresponds to the distance between the first flat plate and the top of the blade adapter.

Further, the bamboo breaking device further includes a second flat plate. The material tube is disposed between the first flat plate and the second flat plate. Four first support rods which around the material tube are disposed between the first flat plate and the second flat plate. The upper end and the lower end of the material tube are provided with flanges. The material tube is fastened between the first flat plate and the second flat plate through the flanges at both ends in cooperation with bolts.

Further, the bottom end of the inside of the material tube is provided with a holder for blade adapter. The holder for blade adapter includes a cylinder and a plurality of connecting pieces arranged around the cylinder. One end of the connecting piece is welded on the cylinder, and the other end of the connecting piece is fixedly connected to the inner wall of the material tube by welding. The blade adapter is arranged above the cylinder. The cylinder and the bottom of the blade adapter are connected by bolts. Each blade on the blade adapter is positioned directly above a connecting piece.

Further, the second flat plate is suspended above the control cabinet. Four second support rods arranged in a matrix are disposed between the second flat plate and the control cabinet. The second flat plate is provided with a drop hole disposed coaxially with the material tube.

Further, a slide rail is disposed under the second flat plate. The slide rail extends obliquely downward towards the outside of the control cabinet from the bottom of the drop hole.

The technical effect of the invention is to provide a strip-making machine for bamboo core barrel with precise center-aligned cutting. The principle is that the bamboo core barrel is delivered into the conveyor belt in a straight and order manner by the rotating tray. The bamboo core barrel is pushed into the bamboo breaking device by the push cylinder on the conveyor belt. After the bamboo core barrel enters into the bamboo breaking device, the bamboo core barrel falls into the material tube and sleeved on the blade adapter. As the shape of the blade adapter is tapered, the bamboo core barrel sleeved on the blade adapter can automatically align its center with the center of the blade adapter. The pressure block is pressed by the driving of the double-stroke hydraulic cylinder, which forces the bamboo core barrel to pass through the blade adapter. The bamboo core barrel is cut into a plurality of strip-shaped materials with equal arc length by a plurality of blades distributed along the circumference of the blade adapter. It can greatly reduce the amount of waste generated during subsequent processing and reduce the production cost.

### BRIEF DESCRIPTION OF THE DRAWINGS

The invention is illustrated by the following figures and embodiments.

FIG. 1 shows a schematic diagram of three-dimensional structure of a strip-making machine for bamboo core barrel with precise center-aligned cutting in accordance with an example embodiment.

FIG. 2 shows a schematic diagram of top view of a strip-making machine for bamboo core barrel with precise center-aligned cutting in accordance with an example embodiment.

FIG. 3 shows a schematic diagram of top view of a strip-making machine for bamboo core barrel with precise center-aligned cutting in accordance with an example embodiment.

FIG. 4 shows a schematic diagram of three-dimensional structure of bamboo breaking device of a strip-making machine for bamboo core barrel with precise center-aligned cutting in accordance with an example embodiment.

FIG. 5 shows a schematic diagram of cross section of bamboo breaking device of a strip-making machine for bamboo core barrel with precise center-aligned cutting in accordance with an example embodiment.

FIG. 6 shows a schematic diagram of the bottom of the material tube of a strip-making machine for bamboo core barrel with precise center-aligned cutting in accordance with an example embodiment.

FIG. 7 shows a schematic diagram of the inside of the material tube of a strip-making machine for bamboo core barrel with precise center-aligned cutting in accordance with an example embodiment.

The reference numbers of the figures are as follows:

1: control cabinet; 2: rotating tray; 3: conveyor belt; 3a: push cylinder; 3a1: material support; 4: bamboo breaking device, 4a: double-stroke hydraulic cylinder; 4a1: pressure block; 4b: first flat plate; 4b1: circular hole; 4c: mounting bracket; 4d: second flat plate; 4d1: drop hole; 4e: first support rod; 4f: second support rod; 4g: slide rail; 5: material tube; 5a: blade adapter; 5a1: blade; 5b: flange; 5c: holder for blade adapter; 5c1: cylinder; 5c2: connecting piece; 6: bamboo core barrel.

### DETAILED DESCRIPTION

The invention is illustrated in accordance with figures. The figures as simplified diagrams demonstrate the basic structures of the apparatus of embodiments of the invention. Thus, the invention is not limited to the figures.

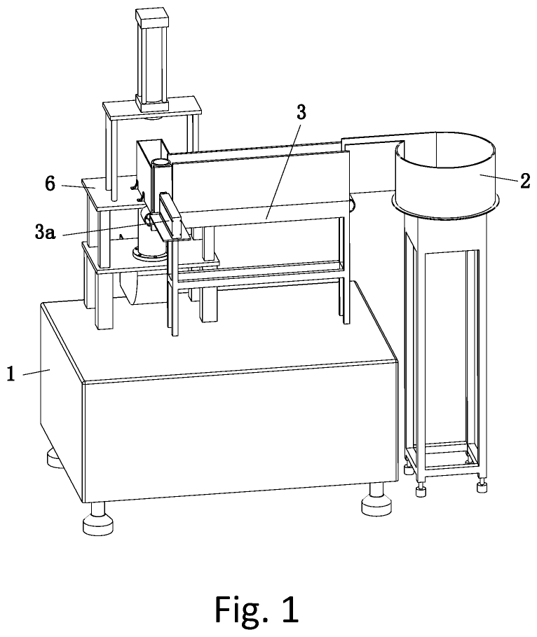

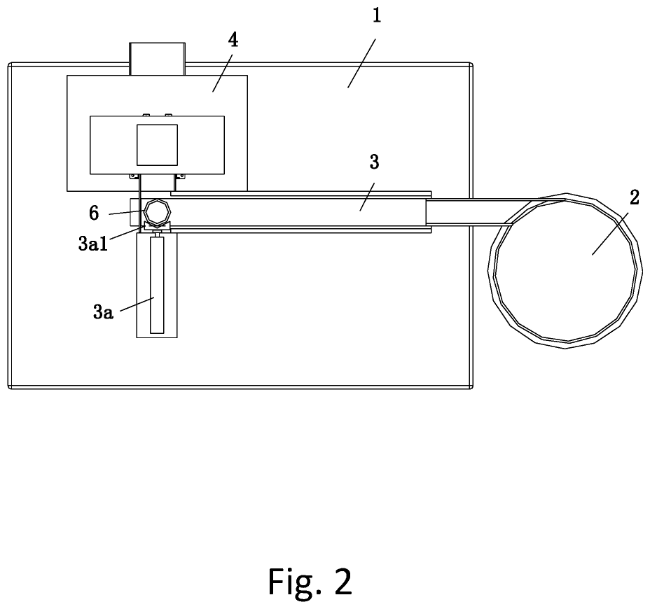

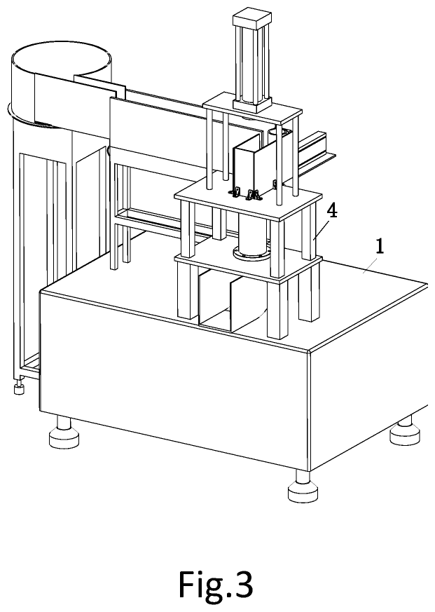

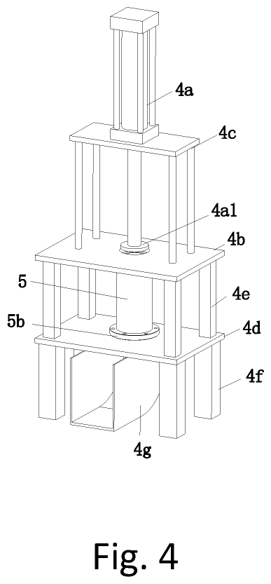

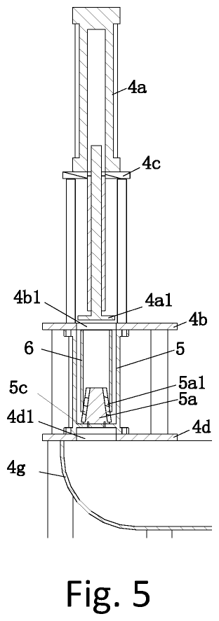

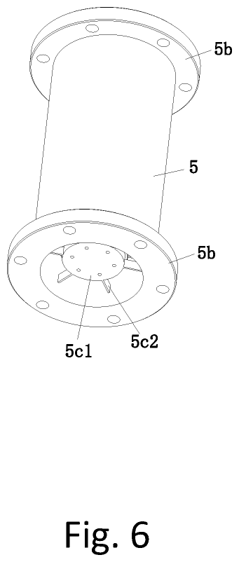

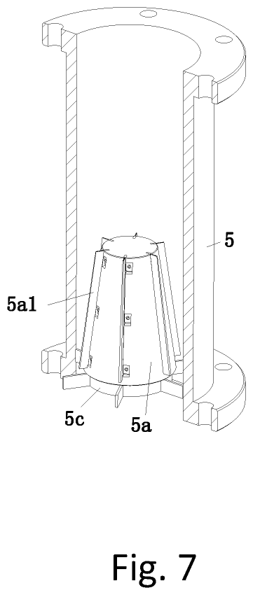

Referring to FIGS. 1-7, a strip-making machine for bamboo core barrel with precise center-aligned cutting includes a control cabinet 1. A rotating tray 2 is arranged on a side of the control cabinet 1. A conveyor belt 3 and a bamboo breaking device 4 are mounted on the control cabinet 1. The conveyor belt 3 is connected between the rotating tray 2 and the bamboo breaking device 4. The bamboo breaking device 4 is provided with a vertically placed material tube 5. A cone-shaped blade adapter 5a is installed below the inside of the material tube 5. A plurality of circumferentially distributed blades 5a1 are mounted on the outer wall of the blade adapter 5a. The bamboo breaking device 4 further includes a double-stroke hydraulic cylinder 4a disposed above the material tube 5. The top of the piston rod of the double-stroke hydraulic cylinder 4a is equipped with a pressure block 4a1. The pressure block 4a1 can be driven into the inside of the material tube 5 by the double-stroke hydraulic cylinder 4a.

The present invention relates to the strips of the bamboo core barrel 6 after cutting. The principle is that the bamboo core barrel 6 is delivered into the conveyor belt 3 in a straight and order manner by the rotating tray 2. The bamboo core barrel 6 is pushed into the bamboo breaking device 4 by the push cylinder 3a on the conveyor belt 3. After the bamboo core barrel 6 enters into the bamboo breaking device 4, the bamboo core barrel 6 falls into the material tube 5 and sleeved on the blade adapter 5a. As the shape of the blade adapter is tapered, the bamboo core barrel 6 sleeved on the blade adapter 5a can automatically align its center with the center of the blade adapter 5a. The pressure block 4a1 is pressed by the driving of the double-stroke hydraulic cylinder 4a, which forces the bamboo core barrel 6 to pass through the blade adapter 5a. The bamboo core barrel 6 is cut into a plurality of strip-shaped materials with equal arc length by a plurality of blades 5a1 distributed along the circumference of the blade adapter 5a.

Baffles are arranged on both sides and the end of the conveyor belt 3. The baffle on both sides are used to prevent the bamboo core barrel 6 from being dumped towards both sides when transported on the conveyor belt 3. The height of the baffle is slightly lower than the height of the bamboo core barrel 6. A push cylinder 3a is mounted on one side of material position of the end of the conveyor belt 3. The pushing direction of the push cylinder 3a is perpendicular to the conveying direction of the conveyor belt 3. The push cylinder 3a is used to push the bamboo core barrel 6 on the material position of the end of the conveyor belt 6 to the bamboo breaking device 4. The corresponding bamboo breaking device 4 is disposed on the side of the conveyor belt 3 and disposed opposite to the push cylinder 3a.

The push cylinder 3a is a three-bar cylinder. An end of three output rod of the push cylinder 3a is equipped with a material support 3a1. The height of the material support 3a1 is slightly lower than the height of bamboo core barrel 6. The use of a three-bar cylinder is more advantageous for fixing the material support 3a1 with such height. The front side of the material support is provided with a curved surface. The curved surface is designed to enlarge the contact area of the material support 3a1 and the bamboo core barrel 6, and make the bamboo core barrel 6 formed into a package, which prevents the bamboo core barrel 6 from shifting towards two sides at the time of delivery.

The bamboo breaking device 4 further includes a first flat plate 4b. The upper end surface of the first flat plate 4b is in the same plane as the bearing surface of the conveyor belt 3. The first flat plate 4b is provided with a circular hole 4b1. The position of the circular hole 4b1 corresponds to the position of the stroke end of the push cylinder 3a. The material tube 5 is installed below the first flat plate 4b and the material tube 5 is disposed coaxially with the circular hole 4b1. The push cylinder 3a can deliver the bamboo core barrel 6 on the material position of the end of the conveyor belt 3 to a position above the circular hole 4b1 of the first flat plate 4b. The bamboo core barrel 6 passes through the circular hole 4b1 by the gravity and fall inside the material tube 5. The first flat plate 4b is further provided with a material path composed of two vertical plates. When the push cylinder 3a pushes the material, the bamboo core barrel 6 passes through the material path to prevent the bamboo core barrel 6 from falling over.

The first flat plate 4b is provided with a mounting bracket 4c. The top of the mounting bracket 4b is suspended above the circular hole 4b1. The double-stroke hydraulic cylinder 4a is fixed above the top of the mounting bracket 4c. The pressure block 4a1 is disposed under the top of the mounting bracket 4c. The piston rod of the double-stroke hydraulic cylinder 4a passes through the top of the mounting bracket 4c and connects to the pressure block 4a1. The first stroke distance of the double-stroke hydraulic cylinder 4a corresponds to the distance between the top of the mounting bracket 4c and the first flat plate 4b. The second stroke distance corresponds to the distance between the first flat plate 4b and the top of the blade adapter 5a. The double-stroke hydraulic cylinder 4a is raised by the mounting bracket 4c. The double-stroke hydraulic cylinder 4a does not block the feeding of the bamboo core barrel 6 when the double-stroke hydraulic cylinder 4a is fully retracted. After the bamboo core barrel 6 enters the material tube 5, the double-stroke hydraulic cylinder 4a first drives the pressure block 4a1 to rapidly move to a position close to the first flat plate 4b. Subsequently, the output force of the double-stroke hydraulic cylinder 4a increases, the speed becomes slow, and the bamboo core barrel 6 is slowly and forcefully pressed down so that the bamboo core barrel 6 is cut.

The bamboo breaking device 4 further includes a second flat plate 4d. The material tube 5 is disposed between the first flat plate 4b and the second flat plate 4d. Four first support rods 4e which around the material tube 5 are disposed between the first flat plate 4b and the second flat plate 4d. The upper end and the lower end of the material tube 5 are provided with flanges 5b. The material tube 5 is fastened between the first flat plate 4b and the second flat plate 4d through the flanges 5b at both ends in cooperation with bolts.

The bottom end of the inside of the material tube 5 is provided with a holder for blade adapter 5c. The holder for blade adapter 5c includes a cylinder 5c1 and a plurality of connecting pieces 5c2 arranged around the cylinder 5c1. One end of the connecting piece 5c2 is welded on the cylinder 5c1, and the other end of the connecting piece 5c2 is fixedly connected to the inner wall of the material tube 5 by welding. The blade adapter 5a is arranged above the cylinder 5c1. The cylinder 5c1 and the bottom of the blade adapter 5a are connected by bolts. Each blade 5a1 on the blade adapter 5a is positioned directly above a connecting piece 5c2. The second flat plate 4d is suspended above the control cabinet 1. Four second support rods 4f arranged in a matrix are disposed between the second flat plate 4d and the control cabinet 1. The second flat plate 4d is provided with a drop hole 4d1 disposed coaxially with the material tube 5. A slide rail 4g is disposed under the second flat plate 4d. The slide rail 4g extends obliquely downward towards the outside of the control cabinet 1 from the bottom of the drop hole. The strip-shaped material formed after the cutting of the bamboo core barrel 6 passes through the gap between the connecting piece 5c2 and the connecting piece 5c2, and after passing through the drop hole 4d1, and drops on the slide rail 4g, and is led out of the control cabinet 1 through the slide rail 4g.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A strip-making machine for bamboo core barrel with precise center-aligned cutting, comprising: a control cabinet 1, wherein a rotating tray 2 is arranged on a side of the control cabinet 1; a conveyor belt 3 and a bamboo breaking device 4 are mounted on the control cabinet 1; the conveyor belt 3 is connected between the rotating tray 2 and the bamboo breaking device 4; the bamboo breaking device 4 is provided with a vertically placed material tube 5; a cone-shaped blade adapter 5a is installed below the inside of the material tube 5; a plurality of circumferentially distributed blades 5a1 are mounted on the outer wall of the blade adapter 5a; the bamboo breaking device 4 further includes a double-stroke hydraulic cylinder 4a disposed above the material tube 5; the top of the piston rod of the double-stroke hydraulic cylinder 4a is equipped with a pressure block 4a1; the pressure block 4a1 can be driven into the inside of the material tube 5 by the double-stroke hydraulic cylinder 4a,
wherein baffles are arranged on both sides and the end of the conveyor belt 3; the height of the baffle corresponds to the height of the bamboo core barrel 6; a push cylinder 3a is mounted on one side of material position of the end of the conveyor belt 3; the pushing direction of the push cylinder 3a is perpendicular to the conveying direction of the conveyor belt 3; the push cylinder 3a is used to push the bamboo core barrel 6 on the material position of the end of the conveyor belt 6 to the bamboo breaking device 4; the corresponding bamboo breaking device 4 is disposed on the side of the conveyor belt 3 and disposed opposite to the push cylinder 3a,
wherein the push cylinder 3a is a three-bar cylinder; an end of three output rod of the push cylinder 3a is equipped with a material support 3a1; the height of the material support 3a1 corresponds to the height of bamboo core barrel 6; the front side of the material support 3a1 is provided with a curved surface,
wherein The bamboo breaking device 4 further includes a first flat plate 4b; the upper end surface of the first flat plate 4b is in the same plane as the bearing surface of the conveyor belt 3; the first flat plate 4b is provided with a circular hole 4b1; the position of the circular hole 4b1 corresponds to the position of the stroke end of the push cylinder 3a; the material tube 5 is installed below the first flat plate 4b and the material tube 5 is disposed coaxially with the circular hole 4b1; the push cylinder 3a can deliver the bamboo core barrel 6 on the material position of the end of the conveyor belt 3 to a position above the circular hole 4b1 of the first flat plate 4b; the bamboo core barrel 6 passes through the circular hole 4b1 by the gravity and fall inside the material tube 5.

2. The strip-making machine for bamboo core barrel with precise center-aligned cutting of claim 1, wherein the first flat plate 4b is provided with a mounting bracket 4c; the top of the mounting bracket 4b is suspended above the circular hole 4b1; the double-stroke hydraulic cylinder 4a is fixed above the top of the mounting bracket 4c; the pressure block 4a1 is disposed under the top of the mounting bracket 4c; the piston rod of the double-stroke hydraulic cylinder 4a passes through the top of the mounting bracket 4c and connects to the pressure block 4a1; the first stroke distance of the double-stroke hydraulic cylinder 4a corresponds to the distance between the top of the mounting bracket 4c and the first flat plate 4b; the second stroke distance corresponds to the distance between the first flat plate 4b and the top of the blade adapter 5a.

3. The strip-making machine for bamboo core barrel with precise center-aligned cutting of claim 1, wherein the bamboo breaking device 4 further includes a second flat plate 4d; the material tube 5 is disposed between the first flat plate 4b and the second flat plate 4d; four first support rods 4e which around the material tube 5 are disposed between the first flat plate 4b and the second flat plate 4d; the upper end and the lower end of the material tube 5 are provided with flanges 5b; the material tube 5 is fastened between the first flat plate 4b and the second flat plate 4d through the flanges 5b at both ends in cooperation with bolts.

4. The strip-making machine for bamboo core barrel with precise center-aligned cutting of claim 1, wherein the bottom end of the inside of the material tube 5 is provided with a holder for blade adapter 5c; the holder for blade adapter 5c includes a cylinder 5c1 and a plurality of connecting pieces 5c2 arranged around the cylinder 5c1; one end of the connecting piece 5c2 is welded on the cylinder 5c1, and the other end of the connecting piece 5c2 is fixedly connected to the inner wall of the material tube 5 by welding; the blade adapter 5a is arranged above the cylinder 5c1; the cylinder 5c1 and the bottom of the blade adapter 5a are connected by bolts; each blade 5a1 on the blade adapter 5a is positioned directly above a connecting piece 5c2.

5. The strip-making machine for bamboo core barrel with precise center-aligned cutting of claim 1, wherein the second flat plate 4d is suspended above the control cabinet 1; four second support rods 4f arranged in a matrix are disposed between the second flat plate 4d and the control cabinet 1; the second flat plate 4d is provided with a drop hole 4d1 disposed coaxially with the material tube 5.

6. The strip-making machine for bamboo core barrel with precise center-aligned cutting of claim 1, wherein a slide rail 4g is disposed under the second flat plate 4d; the slide rail 4g extends obliquely downward towards the outside of the control cabinet 1 from the bottom of the drop hole.
